(19) United States
(12) Patent Application Publication
(10) Pub. No.: US 2020/0067340 A1
(43) Pub. Date: Feb. 27, 2020

(54) DUAL FUNCTION WIRELESS POWER CHARGING DEVICE

(71) Applicant: QUALCOMM Incorporated, San Diego, CA (US)

(72) Inventors: Mayank Batra, Cambridge (GB); Laurence Richardson, Near Ely (GB); Christopher Church, Cambridge (GB); Jonathan Tanner, Sidmouth (GB); Magnus Sommansson, Veberod (SE)

(21) Appl. No.: 16/110,854

(22) Filed: Aug. 23, 2018

(51) Int. Cl. H02J 7/02; H04W 76/10

(52) U.S. Cl. CPC H02J 7/025; H02J 2007/0096; H04W 76/10

(57) ABSTRACT

Methods, systems, and devices for wireless charging are described. A device may be configured to function as a wireless power transmitter or wireless power receiver, or both. In some implementations, the device may be configured with a single coil that may function as a receiver coil and a transmitter coil when desirable. Alternatively, the device may be configured with two separate coils (e.g., a receiver coil to operate as a wireless power receiver and a transmitter coil to operate as a wireless power transmitter).

### BACKGROUND

Portable devices are widely deployed to provide various types of communication and processing features, such as applications that support video streaming, social networking, messaging, voice, and so on. These devices are frequently powered by batteries that need to be recharged periodically, for instance, as a result of performing the various types of communication and functional features. In some examples, these devices may be charged wirelessly via a charging dock or by plugging the devices into an electrical outlet via a charging cord.

### SUMMARY

The described techniques relate to improved methods, systems, devices, and apparatuses that supports wireless charging. A device may be configurable to function as a wireless power receiver and a wireless power transmitter. In some examples, the device may be configured with a single coil that may function as a receiver coil and a transmitter coil when desirable. Alternatively, the device may be configured with two separate coils (e.g., a receiver coil to operate as a wireless power receiver and a transmitter coil to operate as a wireless power transmitter).

A method of wireless charging is described. The method may include receiving, at a first device, a message requesting wireless charging from a second device, performing, between the first device and the second device, a wireless charging setup procedure including authenticating the second device and determining a wireless charging mode of the first device based on the message, the wireless charging mode including at least one of a wireless power receiver mode or a wireless power transmitter mode, selecting the wireless charging mode based on the wireless charging setup procedure, and providing, via the first device, the wireless charging to the second device according to the wireless charging mode.

An apparatus for wireless charging is described. The apparatus may include a processor, memory in electronic communication with the processor, and instructions stored in the memory. The instructions may be executable by the processor to cause the apparatus to receive, at the apparatus, a message requesting wireless charging from a second apparatus, perform, between the apparatus and the second apparatus, a wireless charging setup procedure including authenticating the second apparatus and determining a wireless charging mode of the apparatus based on the message, the wireless charging mode including at least one of a wireless power receiver mode or a wireless power transmitter mode, select the wireless charging mode based on the wireless charging setup procedure, and provide, via the apparatus, the wireless charging to the second apparatus according to the wireless charging mode.

Another apparatus for wireless charging is described. The apparatus may include means for receiving, at the apparatus, a message requesting wireless charging from a second apparatus, performing, between the apparatus and the second apparatus, a wireless charging setup procedure including authenticating the second apparatus and determining a wireless charging mode of the apparatus based on the message, the wireless charging mode including at least one of a wireless power receiver mode or a wireless power transmitter mode, selecting the wireless charging mode based on the wireless charging setup procedure, and providing, via the apparatus, the wireless charging to the second apparatus according to the wireless charging mode.

A non-transitory computer-readable medium storing code for wireless charging is described. The code may include instructions executable by a processor to receive, at a first device, a message requesting wireless charging from a second device, perform, between the first device and the second device, a wireless charging setup procedure including authenticating the second device and determining a wireless charging mode of the first device based on the message, the wireless charging mode including at least one of a wireless power receiver mode or a wireless power transmitter mode, select the wireless charging mode based on the wireless charging setup procedure, and provide, via the first device, the wireless charging to the second device according to the wireless charging mode.

In some examples of the method, apparatuses, and non-transitory computer-readable medium described herein, the first device comprises a single coil configured to operate both in the wireless power receiver mode and the wireless power transmitter mode simultaneously.

Some examples of the method, apparatuses, and non-transitory computer-readable medium described herein may further include operations, features, means, or instructions for configuring a first coil of the first device to operate in the wireless power transmitter mode to wirelessly charge the second device based on selecting the wireless charging mode, where providing the wireless charging to the second device may be based on configuring the first coil of the first device to operate in the wireless power transmitter mode.

Some examples of the method, apparatuses, and non-transitory computer-readable medium described herein may further include operations, features, means, or instructions for configuring a second coil of the first device to operate in the wireless power receiver mode to wirelessly charge the first device, where providing the wireless charging to the second device may be based on configuring the second coil of the first device to operate in the wireless power receiver mode.

Some examples of the method, apparatuses, and non-transitory computer-readable medium described herein may further include operations, features, means, or instructions for identifying a list of previously-connected devices, identifying the second device in the list of previously-connected devices and establishing a connection with the second device based on the second device being in the list of previously-connected devices, where providing the wireless charging setup procedure may be further based on the connection.

In some examples of the method, apparatuses, and non-transitory computer-readable medium described herein, the connection comprises one or more of: a Bluetooth connection, Bluetooth low-energy (BLE) connection, a near-field communication (NFC) connection, or a Wi-Fi connection.

Some examples of the method, apparatuses, and non-transitory computer-readable medium described herein may further include operations, features, means, or instructions for identifying a key value in the message requesting wireless charging, extracting the key value and a key serial number from the message and determining an association of the extracted key value and the extracted key serial number to the second device, where authenticating the second device may be based on the association.

Some examples of the method, apparatuses, and non-transitory computer-readable medium described herein may further include operations, features, means, or instructions for determining a transmit power profile based on the key value and the key serial number, where authenticating the second device may be based on the transmit power profile.

Some examples of the method, apparatuses, and non-transitory computer-readable medium described herein may further include operations, features, means, or instructions for setting a transmit power of the first device based on the transmit power profile, measuring a transmit power of the second device, comparing the set transmit power of the first device to the measured transmit power of the second device and determining that the set transmit power of the first device matches the measured transmit power of the second device, where authenticating the second device may be based on the measured transmit power of the second device matching the set transmit power of the first device.

Some examples of the method, apparatuses, and non-transitory computer-readable medium described herein may further include operations, features, means, or instructions for determining a resonant frequency profile based on the key value and the key serial number, where authenticating the second device may be based on the resonant frequency profile.

Some examples of the method, apparatuses, and non-transitory computer-readable medium described herein may further include operations, features, means, or instructions for setting an operating frequency of the first device based on the resonant frequency profile, detecting an operating frequency of the second device, comparing the set operating frequency of the first device to the detected operating frequency of the second device and determining that the set operating frequency of the first device matches the detected operating frequency of the second device, where authenticating the second device may be based on the detected operating frequency of the second device matching the set operating frequency of the first device.

Some examples of the method, apparatuses, and non-transitory computer-readable medium described herein may further include operations, features, means, or instructions for determining a load pattern profile based on the key value and the key serial number, where authenticating the second device may be based on the load pattern profile.

Some examples of the method, apparatuses, and non-transitory computer-readable medium described herein may further include operations, features, means, or instructions for setting a load pattern of the first device based on the load pattern profile, detecting a load pattern of the second device, comparing the set load pattern of the first device to the detected load pattern of the second device and determining that the load pattern of the first device matches the detected load pattern of the second device, where authenticating the second device may be based on the detected load pattern of the second device matching the load pattern of the first device.

Some examples of the method, apparatuses, and non-transitory computer-readable medium described herein may further include operations, features, means, or instructions for receiving an input including at least one of a tactile input, a voice command, or a gesture, or a combination thereof, where selecting the wireless charging mode for the first device may be based on the input.

Some examples of the method, apparatuses, and non-transitory computer-readable medium described herein may further include operations, features, means, or instructions for receiving, from a third device, a request for wireless charging the second device, the request including an indication of the wireless charging mode and determining that the second device may be within a charging footprint of the first device, where providing the wireless charging to the second device may be based on the request from the third device and that the second device may be within the charging footprint of the first device.

Some examples of the method, apparatuses, and non-transitory computer-readable medium described herein may further include operations, features, means, or instructions for wirelessly charging a battery of the second device according to the wireless charging mode.

### BRIEF DESCRIPTION OF THE DRAWINGS

FIG. 1 illustrates an example of a system for wireless charging that supports a dual function wireless power charging device in accordance with aspects of the present disclosure.

FIG. 2 illustrates an example of a conceptual block diagram that supports a dual function wireless power charging device in accordance with aspects of the present disclosure.

FIG. 3 illustrates an example of a process flow that supports a dual function wireless power charging device in accordance with aspects of the present disclosure.

FIG. 4 shows a block diagram of a device that supports a dual function wireless power charging device in accordance with aspects of the present disclosure.

FIG. 5 shows a block diagram of a charging manager that supports a dual function wireless power charging device in accordance with aspects of the present disclosure.

FIG. 6 shows a diagram of a system including a device that supports a dual function wireless power charging device in accordance with aspects of the present disclosure.

FIGS. 7 through 11 show flowcharts illustrating methods that support a dual function wireless power charging device in accordance with aspects of the present disclosure.

### DETAILED DESCRIPTION

A communication device, which may be otherwise known as a user equipment (UE) may include a receiver coil and function as a wireless power receiver, while a dedicated charging unit (e.g., a wireless charging pad) may have a transmitter coil and function as a wireless power transmitter. Although some devices support wireless charging, these devices are limited by only being capable to function as either a wireless power receiver or a wireless power transmitter. As such, these devices are unable to support being both a wireless power receiver and a wireless power transmitter, either one at a time or simultaneously. With this constraint, only a device configured as a wireless power transmitter may charge one or more devices configured as wireless power receivers. Therefore, a device configured as a wireless power receiver is unable to charge another device configured as a wireless power receiver.

Improving techniques, methods, and related devices for realizing a device configurable to function as both a wireless power transmitter and a wireless power receiver may be desirable based on the above disadvantage. This device may be configured with a single coil that may function as a receiver coil and a transmitter coil when desirable. Alternatively, the device may be configured with two separate coils (e.g., a receiver coil to operate as a wireless power receiver and a transmitter coil to operate as a wireless power transmitter). In some cases, the device may selectively switch between operating as a wireless power receiver and a wireless power transmitter based at least in part on a wireless charging setup procedure. For example, another device requesting wireless charging may be within a charging footprint of the device. Once within the charging footprint, the two devices may perform an authentication procedure. After a successful authentication, the device requesting the wireless charging may trigger the other device to switch into a certain charging mode (e.g., into a wireless power transmitter mode). By implementing the authentication procedure as part of the wireless charging setup procedure may prevent an unauthorized device from being wirelessly charged and provide a mechanism for selecting between power modes on devices that support both wireless power transmission and wireless power reception modes.

Aspects of the disclosure are initially described in the context of a wireless communications system. Aspects of the disclosure are then described in the context of a conceptual block diagram illustrating an example that supports a dual function wireless power charging device, and a process flow illustrating an example of wireless charging. Aspects of the disclosure are further illustrated by and described with reference to apparatus diagrams, system diagrams, and flowcharts that relate to a dual function wireless power charging device.

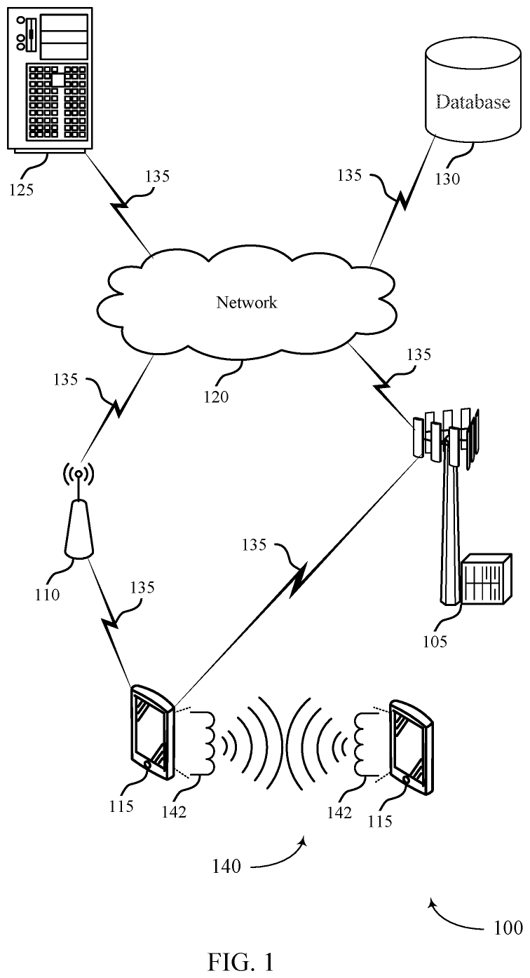

FIG. 1 illustrates an example of a system 100 for wireless charging that supports a dual function wireless power charging device in accordance with aspects of the present disclosure. The system 100 may include a base station 105, an access point 110, devices 115, a server 125, and a database 130. The base station 105, the access point 110, the devices 115, the server 125, and the database 130 may communicate with each other via network 120 using wireless communications links 135.

The base station 105 may wirelessly communicate with the devices 115 via one or more base station antennas. Base station 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The devices 115 described herein may be able to communicate with various types of base stations and network equipment including macro eNBs, small cell eNBs, gNBs, relay base stations, and the like. The access point 110 may be configured to provide wireless communications for the devices 115 over a relatively smaller area compared to the base station 105.

In some examples, the devices 115 may be stationary and/or mobile. In some examples, the devices 115 may include a cellular phone, a smartphone, a digital camera, a standalone camera, a personal digital assistant (PDA), a wireless communication device, a handheld device, a tablet computer, a laptop computer, a cordless phone, a display device (e.g., monitors), and/or the like. The devices 115 may, additionally or alternatively, include or be referred to by those skilled in the art as a UE, a user device, a smartphone, a Bluetooth device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology. In some cases, the devices 115 may also be able to communicate directly with another device (e.g., using a peer-to-peer (P2P) or device-to-device (D2D) protocol).

Some devices 115, such as MTC or IoT devices, may be low cost or low complexity devices, and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay that information to a central server or application program that can make use of the information or present the information to humans interacting with the program or application. Some devices 115 may be designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The devices 115 may be configurable to function as both a wireless power transmitter and a wireless power receiver. In some examples, the devices 115 may be configured with a single coil that may function as a receiver coil and a transmitter coil when desirable. Alternatively, the devices 115 may be configured with two or more separate coils: a receiver coil to operate as a wireless power receiver and a transmitter coil to operate as a wireless power transmitter. The devices 115 may support wireless charging via a magnetic field induction 140 using near ultra-energy field (NULEF) communications. For example, one or more coils 142 of the devices 115 may be a NULEF coil (e.g., NULEF transmitter, NULEF receiver) and communicate information (e.g., messages requesting wireless charging) using the NULEF coils by means of magnetic field induction.

In some examples, the coils 142 may include one or more coils that support wireless charging. For example, the coils 142 may support wireless charging via a magnetic field induction 140 formed between the coils 142 of the devise 115. In some examples, the devices 115 may have a single coil 142 configured to operate both in a wireless power receiver mode and a wireless power transmitter mode simultaneously. Additionally, or alternatively, the devices 115 may have two or more separate coils 142 configured to operate in the wireless power receiver mode and/or the wireless power transmitter mode. For example, the devices 115 may have a first coil that may operate in the wireless power receiver mode, a second coil that may operate in the wireless power transmitter mode, and a third coil that may operate in both the wireless power receiver mode and the wireless power transmitter mode. The coils 142 may be induction coils utilized by the devices 115 to charge its own battery or a battery of another device 115. The battery may be a rechargeable battery, storage battery, secondary cell, or accumulator that may be a type of battery that can be charged, discharged into a load, and recharged.

In some cases, the devices 115 may selectively switch between operating as a wireless power receiver and a wireless power transmitter based at least in part on a wireless charging setup procedure. As part of the procedure, the devices 115 may perform an authentication procedure to authenticate each other to the other device. After a successful authentication, the devices 115 may switch into a certain charging mode (e.g., into a wireless power transmitter mode and/or a wireless power receiver mode). For example, a device 115 configured as wireless power receiver may trigger a device 115 (e.g., support both a wireless power receiver function and a wireless power transmitter function) to switch into a wireless power transmitter mode by first authenticating itself. For example, a mobile phone when placed over a laptop computer authenticates itself and triggers the laptop computer to switch into the wireless power transmitter mode. The authentication may be triggered when the user of the mobile phone presses a button on a user interface of the mobile phone or performs a gesture relative to a camera of the mobile phone to enable wireless charging. The authentication may take place over a connection (e.g., BLE connection) between the two devices and relies on the two devices having paired with each other in the past. Once the authentication succeeds, the mobile phone may request the laptop computer to enter the wireless power transmitter mode over the connection.

By implementing the authentication procedure as part of the wireless charging setup procedure may prevent an unauthenticated device from being wirelessly charged and provide a mechanism for selecting between power modes on devices 115 that support both wireless power transmission and wireless power reception modes. For example, this allows a device 115 (e.g., a laptop that can be charged wirelessly) to also function as a wireless power delivery device, such that the device 115 can charge another device 115 (e.g., a smartphone).

In some cases, devices 115 that have larger batteries (e.g., such as laptop computers) can be used to wirelessly charge devices 115 that have smaller batteries (e.g., such as mobile phones). In addition, devices 115 that have larger batteries can also support being a wireless power transmitter as a secondary function (e.g., soundbar, laptop computer). That is, these devices can wirelessly charge other devices at the same time it is being wirelessly charged. For example, a user places their laptop computer on a charging pad, closes the laptop computers lid and charges their mobile phone, earbuds etc. by placing them over the lid. As an alternative, the user may place all devices over the charging pad, but that requires a larger (and thus more expensive) charging pad. Therefore, it may be desirable to have devices 115 configured to support both wireless power transmission and wireless power reception modes.

The network 120 that may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G) for example), etc. Network 120 may include the Internet.

The server 125 may include any combination of a data server, a cloud server, a server associated with an automation service provider, proxy server, mail server, web server, application server, database server, communications server, home server, mobile server, or any combination thereof. The server 125 may also transmit to the devices 115 a variety of information, such as instructions or commands (e.g., a list of previously-connected devices, a key value and a key serial number associated with a message (e.g., an encrypted message), a transmit power profile, a resonant frequency profile, a load pattern profile, etc.) relevant to supporting wireless charging between the devices 115. The database 130 may store data that may include instructions or commands (e.g., a list of previously-connected devices, a key value and a key serial number associated with a message (e.g., an encrypted message), a transmit power profile, a resonant frequency profile, a load pattern profile, etc.) relevant to supporting wireless charging between the devices 115. The device 115 may retrieve the stored data from the database 130 via the base station 105 and/or the access point 110.

The wireless communications links 135 shown in the system 100 may include uplink transmissions from the devices 115 to the base station 105, the access point 110, or the server 125, and/or downlink transmissions, from the base station 105, the access point 110, the server 125, and/or the database 130 to the devices 115. The downlink transmissions may also be called forward link transmissions while the uplink transmissions may also be called reverse link transmissions. The wireless communications links 135 may transmit bidirectional communications and/or unidirectional communications. Wireless communications links 135 may include one or more connections, including but not limited to, 345 MHz, Wi-Fi, Bluetooth, Bluetooth low-energy (BLE), cellular, Z-WAVE, 802.11, peer-to-peer, LAN, wireless local area network (WLAN), Ethernet, FireWire, fiber optic, and/or other connection types related to wireless communication systems.

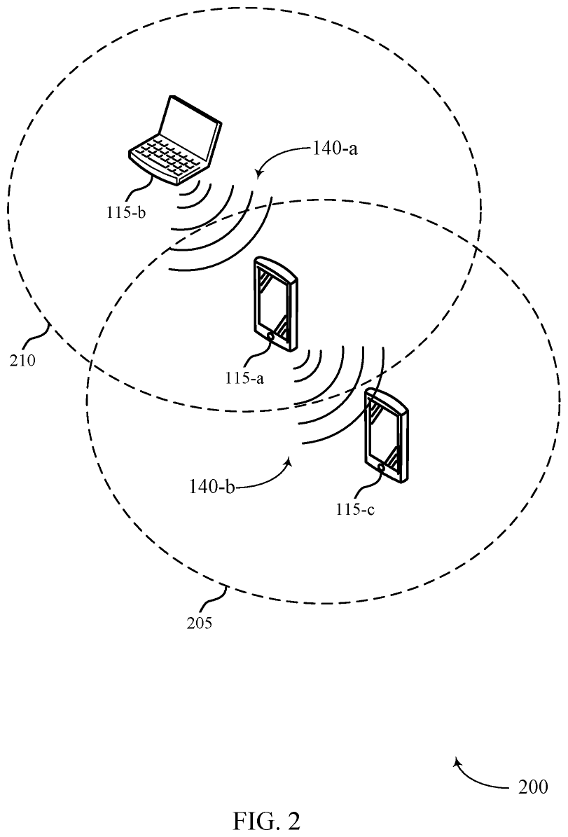

FIG. 2 illustrates an example of a conceptual block diagram 200 that supports a dual function wireless power charging device in accordance with aspects of the present disclosure. In some examples, the conceptual block diagram 200 may implement aspects of the system 100, such as a selectable wireless charging mode. For example, the devices 115-a through 115-c may selectively function as either or both a wireless power receiver and a wireless power transmitter. To support the selectable wireless charging mode, the devices 115-a through 115-c may be configured with a single coil (e.g., an induction coil) that may function as a receiver coil and a transmitter coil when desirable. Alternatively, the devices 115-a through 115-c may be configured with multiple coils, for example, a receiver coil to operate as a wireless power receiver and a transmitter coil to operate as a wireless power transmitter. In the case of multiple coils, the devices 115-a through 115-c may configure different coils to operate in a certain wireless power mode when desirable (e.g., based on whether the device is instructed to wirelessly charge another device or be charged).

By example, the devices 115-a and 115-b may function as both a wireless power receiver and a wireless power transmitter, while the device 115-b may support only being a wireless power receiver. The device 115-a may have a charging footprint 205, while the device 115-b may have a charging footprint 210. In some examples, these charging footprints may be equal or different in size (e.g., range, coverage). As part of initiating a wireless charging setup procedure, the device 115-a may transmit a message requesting wireless charging from the device 115-b. For example, the device 115-a may transmit a message to the device 115-b via a wired connection such as, an Ethernet connection, or an optical fiber connection (e.g., shorter-range multi-mode fiber and long-range single-mode fiber), etc. Alternatively, the device 115-a may transmit a message to the device 115-b via a wireless connection such as, a Bluetooth connection, BLE connection, an NFC connection, a Wi-Fi connection, and NULEF connection, etc.

In some examples, the message requesting wireless charging for the device 115-a may originate from another device (e.g., the device 115-c). For example, the device 115-c may have a software application running on it that enables it to transmit requests and trigger the device 115-b to support wireless charging. Additionally, or alternatively, the device 115-c may transmit a message requesting wireless charging from the device 115-a. In this example, the device 115-b may wirelessly charge the device 115-a, which may wirelessly charge the device 115-c.

In some examples, a wireless power mode may be selected by the devices 115-a through 115-c based at least in part on an input that may include at least one of a tactile input, a voice command, or a gesture, or a combination thereof. In some cases, the device 115-b may have a physical mechanism (e.g., switch, button) located on it that may enable a wireless power mode. For example, any of the devices 115-a through 115-c may have a button that may be pressed by a user to select between a wireless power receiver mode or a wireless transmitter mode. In some examples, the mode may be selected based on a duration of the button being pressed by the user. For example, having the button pressed for a first duration may select the wireless power receiver mode, while having the button pressed for a second duration may select the wireless power transmitter mode. In some cases, the first duration may be shorter than or greater than the second duration. Alternatively, any of the devices 115-a through 115-c may have a switch that may be switched from a first position to a second position. In this case, the first position may be to select the wireless power receiver mode, while the second position may select the wireless power transmitter mode.

Following the reception of the message from the device 115-a (or the device 115-c), the device 115-b may determine whether the device 115-a is within the charging footprint 210. The device 115-b may perform this determination using one or more sensors. For example, the device 115-b may include a sensor that may receive information such as packets, user data, or control information associated with various information channels (e.g., control channels, data channels, and information related to wireless charging, etc.). In some examples, the sensor may be a proximity sensor, such as a hall effect sensor that may sense when a magnetic element of the device 115-a is within the charging footprint 210. In another example, the sensor may be a load sensor or contact sensor that can sense when the device 115-a is in contact with the device 115-b, and therefore within the charging footprint 210. For example, a user may place the device 115-a next to (e.g., adjacent to), above (e.g., on top of), or below the device 115-b to trigger the wireless charging setup procedure. A sensor may also be configured with multiple functionalities. For example, a single sensor may be capable to perform operations related to wireless charging, a proximity sensor, a load sensor, a power sensor, a frequency sensor, or any combination thereof. Similarly, the device 115-a may determine whether the device 115-c is within the charging footprint 205 using one or more of these approaches.

The device 115-b may upon determining that the device 115-a is within the charging footprint 210, and as part of the wireless charging setup procedure, authenticate the device 115-a. Authenticating the device 115-a may help prevent an unauthorized device from being wirelessly charged by the device 115-b. In some examples, the device 115-b may implement an authentication or token scheme with a secret key exchange, such as a cryptographic scheme to authenticate the device 115-a, as described below. Additionally, the device 115-a may implement this authentication or token scheme to authenticate the device 115-c.

In some cases, before or as part of the authenticating, the device 115-b may identify a list of previously-connected devices (e.g., stored in local or remote memory), and identify that the device 115-a is in the list. In some examples, the list may provide an indication of whether the device 115-a has an active authentication or inactive authentication. For example, the device 115-b may be set to provide to a select number of devices the wireless charging operation. That is, a user may register certain devices (e.g., device 115-a) with the device 115-b, and regulate the option to provide wireless charging to the registered devices in a settings of the device 115-b. Therefore, if the device 115-a has an inactive authentication, the device 115-b may ignore its request for wireless charging. Similarly, the device 115-a may identify a list of previously-connected devices to determine whether the device 115-c has an active authentication or inactive authentication, or whether the devices 115-a and 115-c have previously connected (e.g., via a Bluetooth connection) with each other.

Returning to the authentication of the device 115-a, in some cases the device 115-b may identify a key value in the message requesting wireless charging. The key value may be a shared secret key between the devices 115-a and 115-b. In some examples, the shared secret key may have been shared between the devices 115-a and 115-b when establishing a connection with each other, or previously-shared during a previous established connection. The device 115-b may extract the key value and a key serial number from the message. The key serial number may be a unique or a random number associated with the device 115-a to support synchronization between the devices 115-a and 115-b. For example, the serial number may be, an b bit key where b is a positive integer, associated with the device 115-a that is incremented or decremented upon the occurrence of certain events, such as a request for wireless charging.

Following the extraction of the key value and/or key serial number, the device 115-b may determine an association of the extracted key value and the extracted key serial number to the device 115-a. For example, the device 115-b may parse a local memory or remote database to identify a possible match of the extracted key value and the extracted key serial number to the device 115-a. The local memory may be a relational database. The relational database may include a table that may have a set of data elements (e.g., key values, key serial numbers, device identifiers). For example, the table may include a number of columns, and a number of rows. Each row may be associated with a device, and each column may include information (e.g., key value field, key serial number field, previously-connected field, wireless power mode field, transmit power field, a load pattern field, a frequency field, etc.) associated with the device. In some examples, the remote database may also be a relational database. If the device 115-b identifies a match (i.e., an association) of the extracted key value and the extracted key serial number, in the local memory or remote database, to the device 115-a, the device 115-a may be authenticated. Otherwise, the device 115-b may ignore the request for wireless charging. Additionally, or alternatively, the device 115-b may transmit an authentication failure message to the device 115-a. Similarly, the device 115-a may authenticate the device 115-c using one or more of these approaches.

In the case that the device 115-a is successfully authenticated by the device 115-b, it may select a wireless charging mode. For example, the device 115-b may configure a coil to operate in the wireless power transmitter mode, when the device 115-b is configured with a single coil. Alternatively, the device 115-b may configure a coil to operate both in the wireless power transmitter mode and the wireless power receiver mode simultaneously when the device 115-b is configured with a single coil. In another case where the device 115-b is configured with multiple coils, it may configure a first coil to operate in the wireless power transmitter mode to wirelessly charge the device 115-a, and a second coil to operate in the wireless power receiver mode to wirelessly charge the device 115-b. The device 115-b may alternatively be charged by plugging the device 115-b into an electrical outlet via a charging cord. For example, the device 115-b may be a laptop that may be plugged into an electrical outlet using a charging cord. As such, the device 115-b may charge itself via the wired approach, while wirelessly charging other devices simultaneously such as device 115-a.

In some cases, before or as part of the authentication, the device 115-b may determine a hash value (e.g., cryptographic hash) based at least in part on the extracted key value and/or extracted key serial number. The device 115-b may then parse and compare the determined hash value to a hash value stored (e.g., registered) in the local memory or a remote database. In some examples, the hash value may correspond to certain information. For example, the hash value may match (e.g., map to) a hash value, in the local memory of the device 115-b or a remote database, that may correspond to a wireless power mode field, transmit power field, a load pattern field, or a frequency field, etc.

By example, the device 115-b may determine a transmit power profile based at least in part on the hash value (i.e., the key value and the key serial number). The device 115-b may set its transmit power (e.g., in watts (W)) according to the transmit power profile, and measure a transmit power of the device 115-a. The device 115-b may then compare the set transmit power to the measured transmit power of the device 115-a. If the transmit powers match, the device 115-a may be successfully authenticated. In another example, the device 115-b may determine a resonant frequency profile based at least in part on the hash value (i.e., the key value and the key serial number). The device 115-b may set its operating frequency (e.g., in hertz (Hz)) according to the resonant frequency profile, and measure an operating frequency of the device 115-a. The device 115-b may then compare the set operating frequency to the measured operating frequency of the device 115-a. If the operating frequencies match, the device 115-a may be successfully authenticated. As such, the devices 115-a and 115-b may enter a wireless power mode simultaneously and vary their transmit power and/or resonance frequencies in a pattern that is derived based at least in part on the key value and the key serial number that is available to both devices 115-a and 115-b. This variation may be detected by both devices 115-a and 115-b to complete the authentication.

Additionally, or alternatively, the device 115-b may determine a load pattern profile based at least in part on the hash value (i.e., the key value and the key serial number). The device 115-b may set its load pattern according to the load pattern profile, and measure a load pattern of the device 115-a. The device 115-b may then compare the set load pattern to the measured load pattern of the device 115-a. If the load patterns match, the device 115-a may be successfully authenticated. For example, the device 115-b may provide Nwatts of power based on the load pattern profile, and the device 115-a may consume M watts of power. If the provided power is within a threshold range or matches the consumed power, the device 115-a may be authenticated. As such, the devices 115-a and 115-b may enter a wireless power mode simultaneously and also vary their load pattern (e.g., power consumption, and power transmission) that is derived based at least in part on the key value and the key serial number that is available to both devices 115-a and 115-b. This variation may be detected by both devices 115-a and 115-b to complete the authentication. Similarly, the device 115-a may authenticate the device 115-c using one or more of these approaches.

As a result of a successful authentication, the device 115-b may provide the wireless charging to the device 115-a. For example, the device 115-b may wirelessly charge a battery of the device 115-a according to the wireless charging mode via a magnetic field induction 140-a. Additionally, as a result of a successful authentication, the device 115-a may provide the wireless charging to the device 115-c. For example, the device 115-b may wirelessly charge a battery of the device 115-c according to the wireless charging mode via a magnetic field induction 140-b.

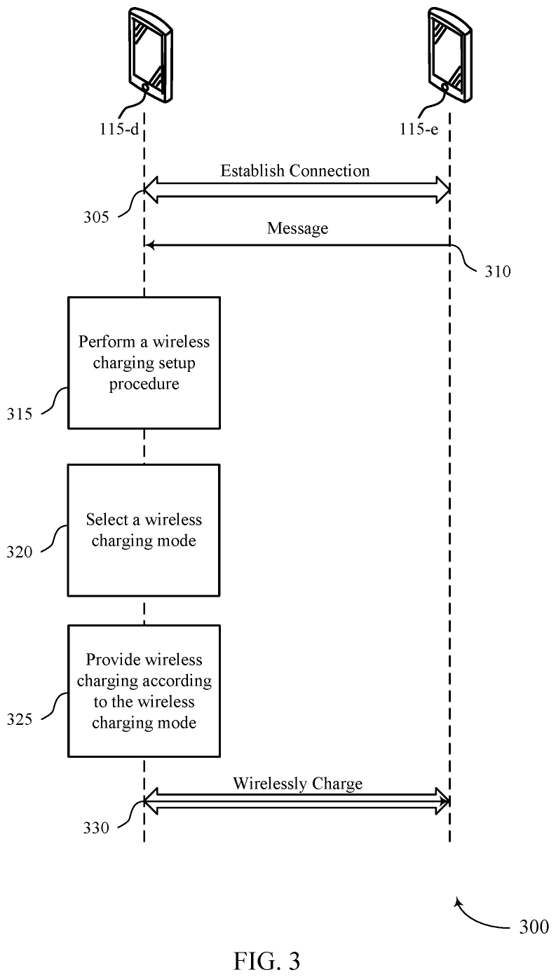

FIG. 3 illustrates an example of a process flow 300 that supports a dual function wireless power charging device in accordance with aspects of the present disclosure. In some examples, the process flow 300 may implement aspects of the system 100. For example, the devices 115-d and 115-e may be examples of the corresponding devices described with reference to FIG. 1. For example, the devices 115-d and 115-e may function as either or both a wireless power receiver and a wireless power transmitter. In the following description of the process flow 300, the operations between the devices 115-d and 115-e may be transmitted in a different order than the exemplary order shown, or the operations performed by the devices 115-d and 115-e may be performed in different orders or at different times. Certain operations may also be left out of the process flow 300, or other operations may be added to the process flow 300.

At 305, the device 115-d may establish a connection with the device 115-e. In some examples, the connection may be a wired connection such as, an Ethernet connection, or an optical fiber connection (e.g., shorter-range multi-mode fiber and long-range single-mode fiber), etc. Alternatively, or additionally, the connection may be a wireless connection such as, a Bluetooth connection, BLE connection, an NFC connection, a Wi-Fi connection, and NULEF connection, etc.

At 310, the device 115-e may transmit a message to the device 115-d requesting wireless charging from the device 115-d. For example, the device 115-e may transmit a message to the device 115-d via the established connection (e.g., Bluetooth connection).

At 315, the device 115-d may perform a wireless charging setup procedure. For example, the device 115-d may authenticate the device 115-e and determine a wireless charging mode for itself based on the message (e.g., an indication of the request to provide wireless charging to the device 115-e). In some cases, as part of the setup procedure, the device 115-d may identify a list of previously-connected devices (e.g., stored in local or remote memory), and identify that the device 115-e is in the list. In some examples, the list may provide an indication of whether the device 115-e has an active authentication or inactive authentication. For example, the device 115-d may be set to provide a select number of devices the wireless charging operation. Therefore, if the device 115-e has an inactive authentication the device 115-d may ignore its request for wireless charging.

In some cases, as part of the authenticating, the device 115-d may identify a key value in the message, transmitted from the device 115-e, requesting wireless charging. For example, the message transmitted from the device 115-e may be encrypted, and the device 115-d may extract the key value and a key serial number from the message. The device 115-d may use the key serial number and key value, associated with the device 115-d, to generate a key value for decrypting the message. In some cases, before generating the key value for decrypting the message, the device 115-d may determine an association of the extracted key value and the extracted key serial number to the device 115-e to authenticate the device 115-e. In some cases, the device 115-e may use the extracted the key value and the key serial number to determine a transmit power profile, a resonant frequency profile, or a load pattern profile, etc.

At 320, the device 115-d may select a wireless charging mode. For example, the device 115-d may select to function in a wireless power transmitter mode to wirelessly charge the device 115-e. In some examples, the device 115-d may have a single coil configured to operate both in a wireless power receiver mode and the wireless power transmitter mode simultaneously. Alternatively, the device 115-d may configure the coil to operate in the wireless power transmitter mode while wirelessly charging the device 115-e. In some examples, the device 115-e may have two coils: one to operate in the wireless power transmitter mode to charge the device 115-e, and the other to operate in the wireless power receiver mode for charging the device 115-e. At 325, the device 115-d may provide wireless charging according to the wireless charging mode. At 330, the device 115-d may wirelessly charge the device 115-e, for example, via a magnetic induction between corresponding coils of the devices 115-d and 115-e.

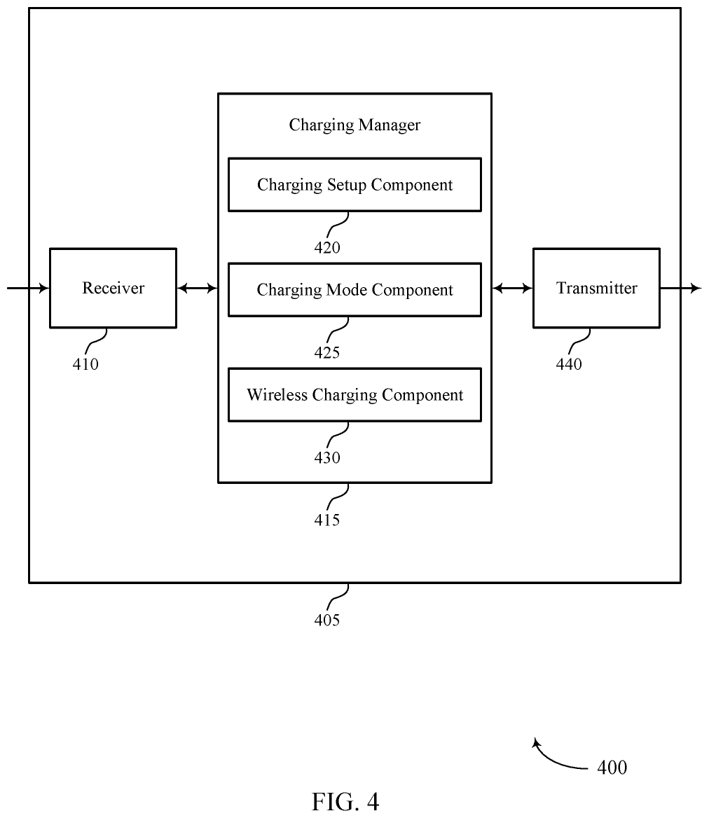

FIG. 4 shows a block diagram 400 of a device 405 that supports a dual function wireless power charging device in accordance with aspects of the present disclosure. The device 405 may be an example of aspects of a device 115 as described herein. The device 405 may include a receiver 410, a charging manager 415, and a transmitter 440. The device 405 may also include a processor. Each of these components may be in communication with one another (e.g., via one or more buses).

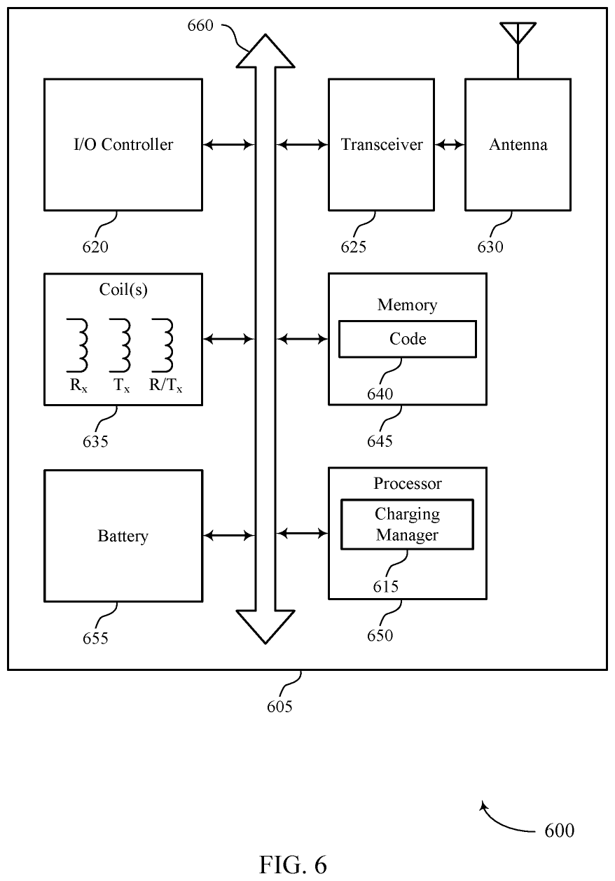

The receiver 410 may receive information such as packets, user data, or control information associated with various information channels (e.g., control channels, data channels, and information related to a dual function wireless power charging device, etc.). Information may be passed on to other components of the device 405. The receiver 410 may be an example of aspects of the transceiver 625 described with reference to FIG. 6. The receiver 410 may utilize a single antenna or a set of antennas.

The receiver 410 may receive a message requesting wireless charging from a second device. In some examples, the receiver 410 may receive an input including at least one of a tactile input, a voice command, or a gesture, or a combination thereof, where selecting a wireless charging mode for the device 405 is based on the input. In some examples, the receiver 410 may receive, from a third device, a request for wireless charging a second device, the request including an indication of the wireless charging mode.

The charging manager 415 may include a charging setup component 420, a charging mode component 425, and a wireless charging component 430. The charging manager 415 may be an example of aspects of the charging manager 615 described herein. The charging setup component 420 may perform, between the device 405 and the second device, a wireless charging setup procedure including authenticating the second device and determining a wireless charging mode of the device 405 based on the message, the wireless charging mode including at least one of a wireless power receiver mode or a wireless power transmitter mode. The charging mode component 425 may select the wireless charging mode based on the wireless charging setup procedure. The wireless charging component 430 may provide, via the device 405, the wireless charging to the second device according to the wireless charging mode.

The charging manager 415, or its sub-components, may be implemented in hardware, code (e.g., software or firmware) executed by a processor, or any combination thereof. If implemented in code executed by a processor, the functions of the charging manager 415, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The charging manager 415, or its sub-components, may be physically located at various positions, including being distributed such that portions of functions are implemented at different physical locations by one or more physical components. In some examples, the charging manager 415, or its sub-components, may be a separate and distinct component in accordance with various aspects of the present disclosure. In some examples, the charging manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

As detailed above, charging manager 415 and/or one or more components of the charging manager 415 may perform and/or be a means for performing, either alone or in combination with other elements, one or more operations for dual function wireless charging.

The transmitter 440 may transmit signals generated by other components of the device 405. In some examples, the transmitter 440 may be collocated with a receiver 410 in a transceiver module. For example, the transmitter 440 may be an example of aspects of the transceiver 625 described with reference to FIG. 6. The transmitter 440 may utilize a single antenna or a set of antennas.

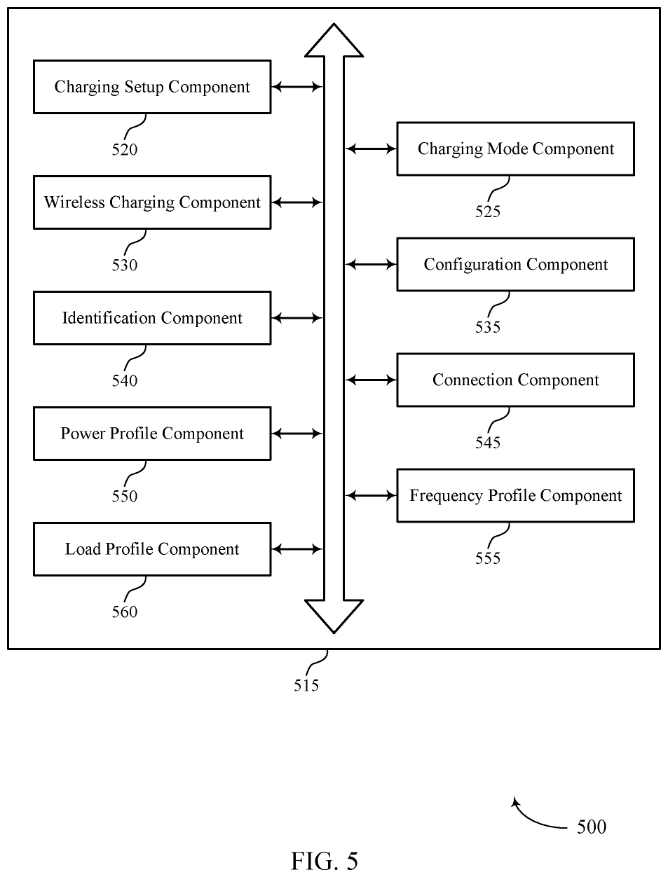

FIG. 5 shows a block diagram 500 of a charging manager 515 that supports a dual function wireless power charging device in accordance with aspects of the present disclosure. The charging manager 515 may be an example of aspects of a charging manager 415 or a charging manager 615 described herein. The charging manager 515 may include a charging setup component 520, a charging mode component 525, a wireless charging component 530, a configuration component 535, an identification component 540, a connection component 545, a power profile component 550, a frequency profile component 555, and a load profile component 560. Each of these modules may communicate, directly or indirectly, with one another (e.g., via one or more buses).

The charging setup component 520 may perform, between a first device and a second device, a wireless charging setup procedure including authenticating the second device and determining a wireless charging mode of the first device based on the message, the wireless charging mode including at least one of a wireless power receiver mode or a wireless power transmitter mode.

In some examples, the charging setup component 520 may identify a key value in the message requesting wireless charging. In some examples, the charging setup component 520 may extract the key value and a key serial number from the message. In some examples, the charging setup component 520 may determine an association of the extracted key value and the extracted key serial number to the second device, where authenticating the second device is based on the association. In some examples, the charging setup component 520 may determine that the second device is within a charging footprint of the first device, where providing the wireless charging to the second device is based on the request from the third device and that the second device is within the charging footprint of the first device.

The charging mode component 525 may select the wireless charging mode based on the wireless charging setup procedure. The wireless charging component 530 may provide, via the first device, the wireless charging to the second device according to the wireless charging mode. In some examples, the wireless charging component 530 may wirelessly charge a battery of the second device according to the wireless charging mode.

The configuration component 535 may configure a first coil of the first device to operate in the wireless power transmitter mode to wirelessly charge the second device based on selecting the wireless charging mode, where providing the wireless charging to the second device is based on configuring the first coil of the first device to operate in the wireless power transmitter mode. In some examples, the configuration component 535 may configure a second coil of the first device to operate in the wireless power receiver mode to wirelessly charge the first device, where providing the wireless charging to the second device is based on configuring the second coil of the first device to operate in the wireless power receiver mode.

The identification component 540 may identify a list of previously-connected devices. In some examples, the identification component 540 may identify the second device in the list of previously-connected devices. The connection component 545 may establish a connection with the second device based on the second device being in the list of previously-connected devices, where providing the wireless charging setup procedure is further based on the connection.

The power profile component 550 may determine a transmit power profile based on the key value and the key serial number, where authenticating the second device is based on the transmit power profile. In some examples, the power profile component 550 may set a transmit power of the first device based on the transmit power profile. In some examples, the power profile component 550 may measure a transmit power of the second device. In some examples, the power profile component 550 may compare the set transmit power of the first device to the measured transmit power of the second device. In some examples, the power profile component 550 may determine that the set transmit power of the first device matches the measured transmit power of the second device, where authenticating the second device is based on the measured transmit power of the second device matching the set transmit power of the first device.

The frequency profile component 555 may determine a resonant frequency profile based on the key value and the key serial number, where authenticating the second device is based on the resonant frequency profile. In some examples, the frequency profile component 555 may set an operating frequency of the first device based on the resonant frequency profile. In some examples, the frequency profile component 555 may detect an operating frequency of the second device. In some examples, the frequency profile component 555 may compare the set operating frequency of the first device to the detected operating frequency of the second device. In some examples, the frequency profile component 555 may determine that the set operating frequency of the first device matches the detected operating frequency of the second device, where authenticating the second device is based on the detected operating frequency of the second device matching the set operating frequency of the first device.

The load profile component 560 may determine a load pattern profile based on the key value and the key serial number, where authenticating the second device is based on the load pattern profile. In some examples, the load profile component 560 may set a load pattern of the first device based on the load pattern profile. In some examples, the load profile component 560 may detect a load pattern of the second device. In some examples, the load profile component 560 may compare the set load pattern of the first device to the detected load pattern of the second device. In some examples, the load profile component 560 may determine that the load pattern of the first device matches the detected load pattern of the second device, where authenticating the second device is based on the detected load pattern of the second device matching the load pattern of the first device.

As detailed above, charging manager 515 and/or one or more components of the charging manager 515 may perform and/or be a means for performing, either alone or in combination with other elements, one or more operations for dual function wireless charging.

FIG. 6 shows a diagram of a system 600 including a device 605 that supports a dual function wireless power charging device in accordance with aspects of the present disclosure. The device 605 may be an example of or include the components of device 405, or a device as described herein. The device 605 may include components for bi-directional voice and data communications including components for transmitting and receiving communications, including a charging manager 615, an I/O controller 620, a transceiver 625, an antenna 630, coil(s) 635, memory 645, a processor 650, and a battery 655. These components may be in electronic communication via one or more buses (e.g., bus 660).

The charging manager 615 may receive a message requesting wireless charging from a second device, perform, between the device 605 and the second device, a wireless charging setup procedure including authenticating the second device and determining a wireless charging mode of the device 605 based on the message, the wireless charging mode including at least one of a wireless power receiver mode or a wireless power transmitter mode, select the wireless charging mode based on the wireless charging setup procedure, and provide, via the device 605, the wireless charging to the second device according to the wireless charging mode.

The I/O controller 620 may manage input and output signals for the device 605. The I/O controller 620 may also manage peripherals not integrated into the device 605. In some cases, the I/O controller 620 may represent a physical connection or port to an external peripheral. In some cases, the I/O controller 620 may utilize an operating system such as iOS, Android, MS-DOS, MS-Windows, OS/X, Unix, Linux, or another known operating system. In other cases, the I/O controller 620 may represent or interact with a modem, a keyboard, a mouse, a touchscreen, or a similar device. In some cases, the I/O controller 620 may be implemented as part of a processor. In some cases, a user may interact with the device 605 via the I/O controller 620 or via hardware components controlled by the I/O controller 620.

The transceiver 625 may communicate bi-directionally, via one or more antennas, wired, or wireless links as described above. For example, the transceiver 625 may represent a wireless transceiver and may communicate bi-directionally with another wireless transceiver. The transceiver 625 may also include a modem to modulate the packets and provide the modulated packets to the antennas for transmission, and to demodulate packets received from the antennas. In some cases, the device 605 may include a single antenna 630. However, in some cases, the device 605 may have more than one antenna 630, which may be capable of concurrently transmitting or receiving multiple wireless transmissions.

The coil(s) 635 may include one or more coils that support wireless charging. In some examples, the device 605 may have a single coil 635 configured to operate both in a wireless power receiver mode and a wireless power transmitter mode simultaneously. Additionally, or alternatively, the device 605 may have two or more separate coils 635 configured to operate in the wireless power receiver mode and/or the wireless power transmitter mode. For example, the device 605 may have a coil that may operate in the wireless power receiver mode (Rₓ), a second coil that may operate in the wireless power transmitter mode (Tₓ), and a third coil that may operate in both the wireless power receiver mode and the wireless power transmitter mode (R/Tₓ). The coil(s) 635 may be induction coils utilized by the charging manager 615 to charge battery 655, which may be a rechargeable battery, storage battery, secondary cell, or accumulator that may be a type of battery that can be charged, discharged into a load, and recharged. Battery 655 may include one or more different combinations of electrode materials and electrolytes including: lead-acid, nickel-cadmium (NiCd), nickel-metal hydride (NiMH), lithium-ion (Li-ion), and lithium polymer (Li-ion polymer), etc. In some cases, the coil(s) 635 may be induction coils utilized by the charging manager 615 to charge a battery of another device. As such, the device 605 may be configured to both wirelessly charge other devices and/or be wirelessly charged by another device.

The code 640 may include instructions to implement aspects of the present disclosure, including instructions to support wireless charging. The code 640 may be stored in a non-transitory computer-readable medium such as system memory or other type of memory. In some cases, the code 640 may not be directly executable by the processor 640 but may cause a computer (e.g., when compiled and executed) to perform functions described herein.

The memory 645 may random access memory (RAM) and read only memory (ROM). The memory 645 may, additionally or alternatively, include static RAM (SRAM), dynamic RAM (DRAM), electrically erasable programmable read-only memory (EEPROM), compact disk-ROM (CD-ROM) or other optical disc storage, magnetic disc storage, or other magnetic storage devices, flash memory, or any other medium that can be used to store desired program code in the form of instructions or data structures and that can be accessed by a computer or the processor 650. The memory 645 may store computer-readable, computer-executable code 640 including instructions that, when executed, cause the processor to perform various functions described herein. In some cases, the memory 645 may contain, among other things, a BIOS which may control basic hardware or software operation such as the interaction with peripheral components or devices.

The processor 650 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 650 may be configured to operate a memory array using a memory controller. In other cases, a memory controller may be integrated into the processor 650. The processor 650 may be configured to execute computer-readable instructions stored in a memory (e.g., the memory 645) to cause the device 605 to perform various functions (e.g., functions or tasks supporting dual function wireless power charging).

As detailed above, charging manager 615 and/or one or more components of the charging manager 615 may perform and/or be a means for performing, either alone or in combination with other elements, one or more operations for dual function wireless charging.

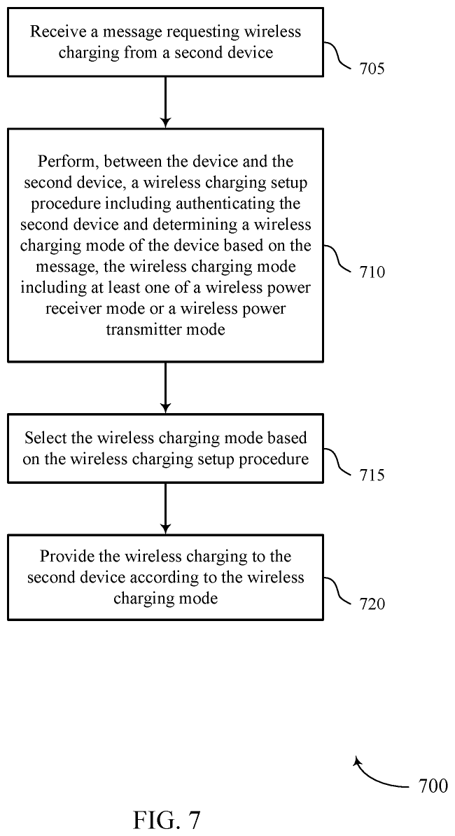

FIG. 7 shows a flowchart illustrating a method 700 that supports a dual function wireless power charging device in accordance with aspects of the present disclosure. The operations of method 700 may be implemented by a device or its components as described herein. For example, the operations of method 700 may be performed by a charging manager as described with reference to FIGS. 4 through 6. In some examples, a device may execute a set of instructions to control the functional elements of the device to perform the functions described below. Additionally, or alternatively, a device may perform aspects of the functions described below using special-purpose hardware.

At 705, the device may receive a message requesting wireless charging from a second device. The operations of 705 may be performed according to the methods described herein. In some examples, aspects of the operations of 705 may be performed by a receiver as described with reference to FIGS. 4 through 6.

At 710, the device may perform, between the device and the second device, a wireless charging setup procedure including authenticating the second device and determining a wireless charging mode of the device based on the message, the wireless charging mode including at least one of a wireless power receiver mode or a wireless power transmitter mode. The operations of 710 may be performed according to the methods described herein. In some examples, aspects of the operations of 710 may be performed by a charging setup component as described with reference to FIGS. 4 through 6.

At 715, the device may select the wireless charging mode based on the wireless charging setup procedure. The operations of 715 may be performed according to the methods described herein. In some examples, aspects of the operations of 715 may be performed by a charging mode component as described with reference to FIGS. 4 through 6.

At 720, the device may provide the wireless charging to the second device according to the wireless charging mode. The operations of 720 may be performed according to the methods described herein. In some examples, aspects of the operations of 720 may be performed by a wireless charging component as described with reference to FIGS. 4 through 6.

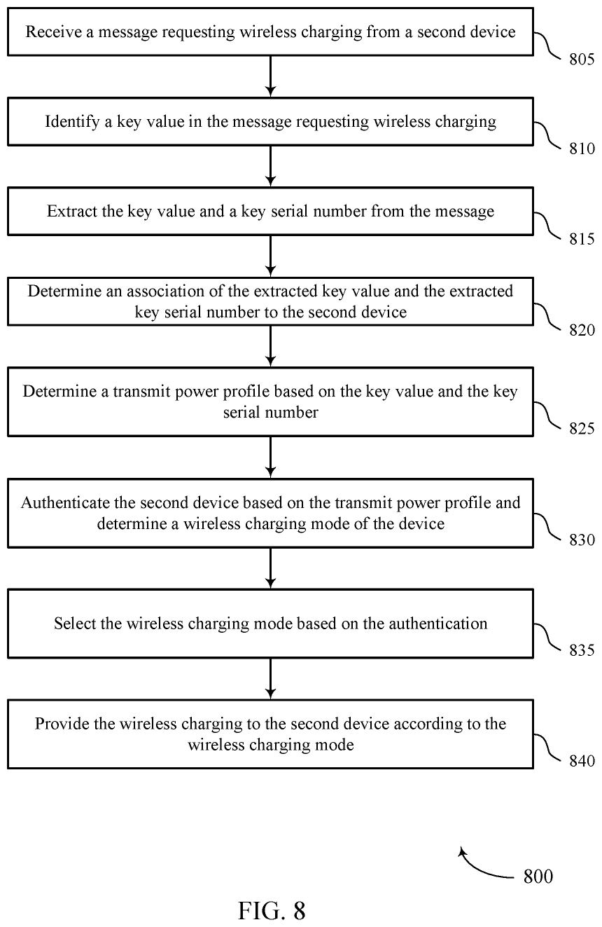

FIG. 8 shows a flowchart illustrating a method 800 that supports a dual function wireless power charging device in accordance with aspects of the present disclosure. The operations of method 800 may be implemented by a device or its components as described herein. For example, the operations of method 800 may be performed by a charging manager as described with reference to FIGS. 4 through 6. In some examples, a device may execute a set of instructions to control the functional elements of the device to perform the functions described below. Additionally, or alternatively, a device may perform aspects of the functions described below using special-purpose hardware.

At 805, the device may receive a message requesting wireless charging from a second device. The operations of 805 may be performed according to the methods described herein. In some examples, aspects of the operations of 805 may be performed by a receiver as described with reference to FIGS. 4 through 6.

At 810, the device may identify a key value in the message requesting wireless charging. The operations of 810 may be performed according to the methods described herein. In some examples, aspects of the operations of 810 may be performed by a charging setup component as described with reference to FIGS. 4 through 6.

At 815, the device may extract the key value and a key serial number from the message. The operations of 815 may be performed according to the methods described herein. In some examples, aspects of the operations of 815 may be performed by a charging setup component as described with reference to FIGS. 4 through 6.

At 820, the device may determine an association of the extracted key value and the extracted key serial number to the second device. The operations of 820 may be performed according to the methods described herein. In some examples, aspects of the operations of 820 may be performed by a charging setup component as described with reference to FIGS. 4 through 6.

At 825, the device may determine a transmit power profile based on the key value and the key serial number. The operations of 825 may be performed according to the methods described herein. In some examples, aspects of the operations of 825 may be performed by a power profile component as described with reference to FIGS. 4 through 6.

At 830, the device may authenticate the second device based on the transmit power profile and determine a wireless charging mode of the device. In some examples, a wireless charging setup procedure may include the authenticating. The operations of 830 may be performed according to the methods described herein. In some examples, aspects of the operations of 830 may be performed by a power profile component as described with reference to FIGS. 4 through 6.

At 835, the device may select the wireless charging mode based on the authentication. The operations of 835 may be performed according to the methods described herein. In some examples, aspects of the operations of 835 may be performed by a charging mode component as described with reference to FIGS. 4 through 6.

At 840, the device may provide the wireless charging to the second device according to the wireless charging mode. The operations of 840 may be performed according to the methods described herein. In some examples, aspects of the operations of 840 may be performed by a wireless charging component as described with reference to FIGS. 4 through 6.

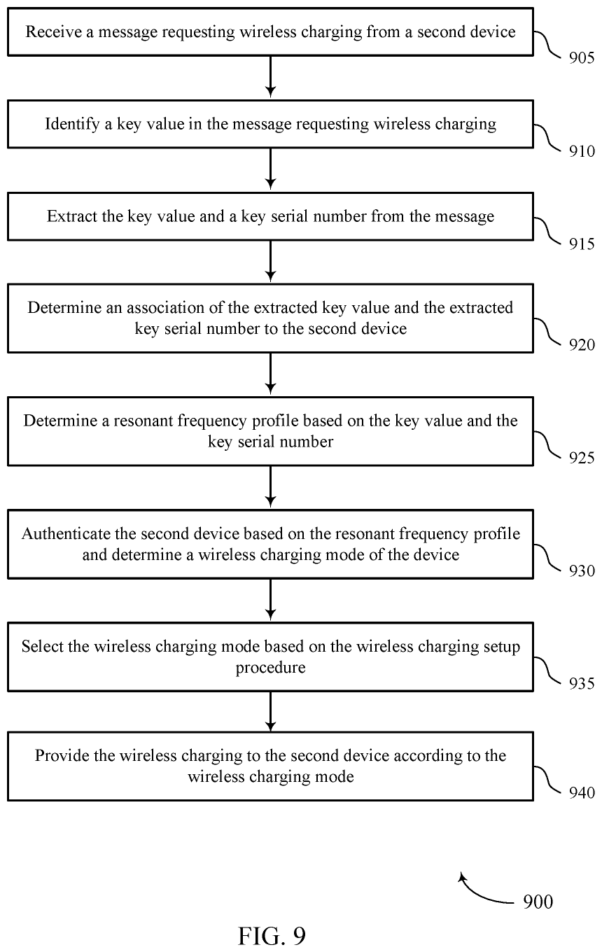

FIG. 9 shows a flowchart illustrating a method 900 that supports a dual function wireless power charging device in accordance with aspects of the present disclosure. The operations of method 900 may be implemented by a device or its components as described herein. For example, the operations of method 900 may be performed by a charging manager as described with reference to FIGS. 4 through 6. In some examples, a device may execute a set of instructions to control the functional elements of the device to perform the functions described below. Additionally, or alternatively, a device may perform aspects of the functions described below using special-purpose hardware.

At 905, the device may receive a message requesting wireless charging from a second device. The operations of 905 may be performed according to the methods described herein. In some examples, aspects of the operations of 905 may be performed by a receiver as described with reference to FIGS. 4 through 6.

At 910, the device may identify a key value in the message requesting wireless charging. The operations of 910 may be performed according to the methods described herein. In some examples, aspects of the operations of 910 may be performed by a charging setup component as described with reference to FIGS. 4 through 6.

At 915, the device may extract the key value and a key serial number from the message. The operations of 915 may be performed according to the methods described herein. In some examples, aspects of the operations of 915 may be performed by a charging setup component as described with reference to FIGS. 4 through 6.

At 920, the device may determine an association of the extracted key value and the extracted key serial number to the second device. The operations of 920 may be performed according to the methods described herein. In some examples, aspects of the operations of 920 may be performed by a charging setup component as described with reference to FIGS. 4 through 6.

At 925, the device may determine a resonant frequency profile based on the key value and the key serial number. The operations of 925 may be performed according to the methods described herein. In some examples, aspects of the operations of 925 may be performed by a frequency profile component as described with reference to FIGS. 4 through 6.

At 930, the device may authenticate the second device based on the resonant frequency profile and determine a wireless charging mode of the device. In some examples, a wireless charging setup procedure may include the authenticating. The operations of 930 may be performed according to the methods described herein. In some examples, aspects of the operations of 930 may be performed by a frequency profile component as described with reference to FIGS. 4 through 6.

At 935, the device may select the wireless charging mode based on the wireless charging setup procedure. The operations of 935 may be performed according to the methods described herein. In some examples, aspects of the operations of 935 may be performed by a charging mode component as described with reference to FIGS. 4 through 6.

At 940, the device may provide the wireless charging to the second device according to the wireless charging mode. The operations of 940 may be performed according to the methods described herein. In some examples, aspects of the operations of 940 may be performed by a wireless charging component as described with reference to FIGS. 4 through 6.

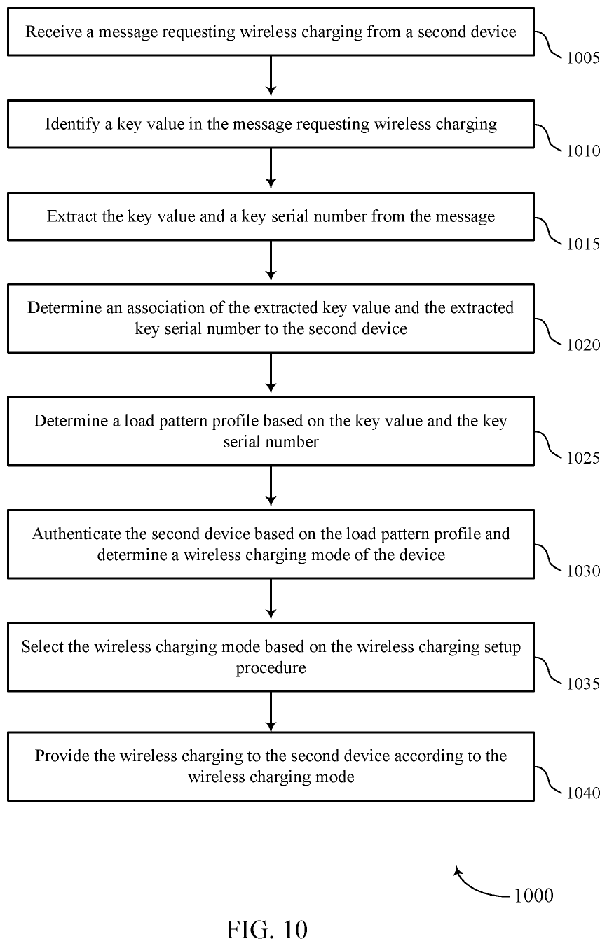

FIG. 10 shows a flowchart illustrating a method 1000 that supports a dual function wireless power charging device in accordance with aspects of the present disclosure. The operations of method 1000 may be implemented by a device or its components as described herein. For example, the operations of method 1000 may be performed by a charging manager as described with reference to FIGS. 4 through 6. In some examples, a device may execute a set of instructions to control the functional elements of the device to perform the functions described below. Additionally, or alternatively, a device may perform aspects of the functions described below using special-purpose hardware.

At 1005, the device may receive a message requesting wireless charging from a second device. The operations of 1005 may be performed according to the methods described herein. In some examples, aspects of the operations of 1005 may be performed by a receiver as described with reference to FIGS. 4 through 6.

At 1010, the device may identify a key value in the message requesting wireless charging. The operations of 1010 may be performed according to the methods described herein. In some examples, aspects of the operations of 1010 may be performed by a charging setup component as described with reference to FIGS. 4 through 6.

At 1015, the device may extract the key value and a key serial number from the message. The operations of 1015 may be performed according to the methods described herein. In some examples, aspects of the operations of 1015 may be performed by a charging setup component as described with reference to FIGS. 4 through 6.

At 1020, the device may determine an association of the extracted key value and the extracted key serial number to the second device. The operations of 1020 may be performed according to the methods described herein. In some examples, aspects of the operations of 1020 may be performed by a charging setup component as described with reference to FIGS. 4 through 6.

At 1025, the device may determine a load pattern profile based on the key value and the key serial number. The operations of 1025 may be performed according to the methods described herein. In some examples, aspects of the operations of 1025 may be performed by a frequency profile component as described with reference to FIGS. 4 through 6.

At 1030, the device may authenticate the second device based on the load pattern profile and determine a wireless charging mode of the device. In some examples, a wireless charging setup procedure may include the authenticating. The operations of 1030 may be performed according to the methods described herein. In some examples, aspects of the operations of 1030 may be performed by a frequency profile component as described with reference to FIGS. 4 through 6.

At 1035, the device may select the wireless charging mode based on the wireless charging setup procedure. The operations of 1035 may be performed according to the methods described herein. In some examples, aspects of the operations of 1035 may be performed by a charging mode component as described with reference to FIGS. 4 through 6.

At 1040, the device may provide the wireless charging to the second device according to the wireless charging mode. The operations of 1040 may be performed according to the methods described herein. In some examples, aspects of the operations of 1040 may be performed by a wireless charging component as described with reference to FIGS. 4 through 6.

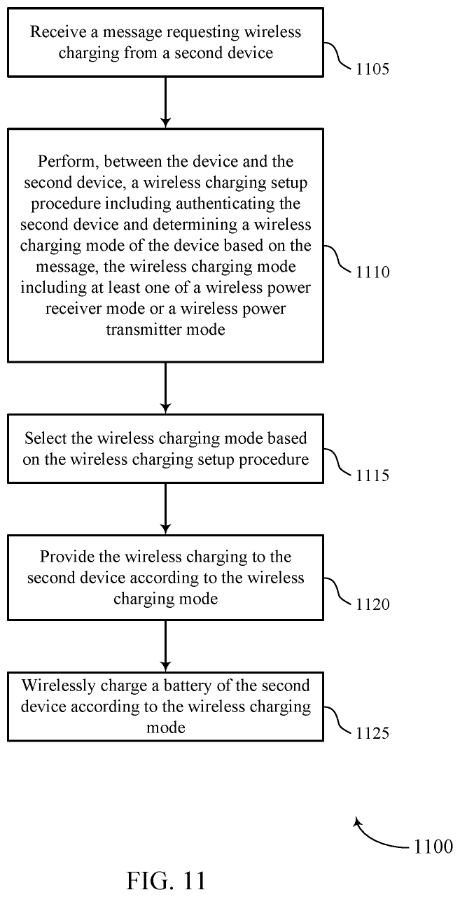

FIG. 11 shows a flowchart illustrating a method 1100 that supports a dual function wireless power charging device in accordance with aspects of the present disclosure. The operations of method 1100 may be implemented by a device or its components as described herein. For example, the operations of method 1100 may be performed by a charging manager as described with reference to FIGS. 4 through 6. In some examples, a device may execute a set of instructions to control the functional elements of the device to perform the functions described below. Additionally, or alternatively, a device may perform aspects of the functions described below using special-purpose hardware.

At 1105, the device may receive a message requesting wireless charging from a second device. The operations of 1105 may be performed according to the methods described herein. In some examples, aspects of the operations of 1105 may be performed by a receiver as described with reference to FIGS. 4 through 6.

At 1110, the device may perform, between the device and the second device, a wireless charging setup procedure including authenticating the second device and determining a wireless charging mode of the device based on the message, the wireless charging mode including at least one of a wireless power receiver mode or a wireless power transmitter mode. The operations of 1110 may be performed according to the methods described herein. In some examples, aspects of the operations of 1110 may be performed by a charging setup component as described with reference to FIGS. 4 through 6.

At 1115, the device may select the wireless charging mode based on the wireless charging setup procedure. The operations of 1115 may be performed according to the methods described herein. In some examples, aspects of the operations of 1115 may be performed by a charging mode component as described with reference to FIGS. 4 through 6.

At 1120, the device may provide the wireless charging to the second device according to the wireless charging mode. The operations of 1120 may be performed according to the methods described herein. In some examples, aspects of the operations of 1120 may be performed by a wireless charging component as described with reference to FIGS. 4 through 6.

At 1125, the device may wirelessly charge a battery of the second device according to the wireless charging mode. The operations of 1125 may be performed according to the methods described herein. In some examples, aspects of the operations of 1125 may be performed by a wireless charging component as described with reference to FIGS. 4 through 6.

It should be noted that the methods described herein describe possible implementations, and that the operations and the steps may be rearranged or otherwise modified and that other implementations are possible. Further, aspects from two or more of the methods may be combined.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for wireless charging, comprising:
receiving, at a first device, a message requesting wireless charging from a second device;
performing, between the first device and the second device, a wireless charging setup procedure comprising authenticating the second device and determining a wireless charging mode of the first device based at least in part on the message, the wireless charging mode comprising at least one of a wireless power receiver mode or a wireless power transmitter mode;
selecting the wireless charging mode based at least in part on the wireless charging setup procedure; and
providing, via the first device, the wireless charging to the second device according to the wireless charging mode.

2. The method of claim 1, wherein the first device comprises a single coil configured to operate both in the wireless power receiver mode and the wireless power transmitter mode simultaneously.

3. The method of claim 1, further comprising:
configuring a first coil of the first device to operate in the wireless power transmitter mode to wirelessly charge the second device based at least in part on selecting the wireless charging mode,
wherein providing the wireless charging to the second device is based at least in part on configuring the first coil of the first device to operate in the wireless power transmitter mode.

4. The method of claim 3, further comprising:
configuring a second coil of the first device to operate in the wireless power receiver mode to wirelessly charge the first device,
wherein providing the wireless charging to the second device is based at least in part on configuring the second coil of the first device to operate in the wireless power receiver mode.

5. The method of claim 1, further comprising:
identifying a list of previously-connected devices;
identifying the second device in the list of previously-connected devices; and
establishing a connection with the second device based at least in part on the second device being in the list of previously-connected devices,
wherein providing the wireless charging setup procedure is further based at least in part on the connection.

6. The method of claim 5, wherein the connection comprises one or more of: a Bluetooth connection, Bluetooth low-energy (BLE) connection, a near-field communication (NFC) connection, or a Wi-Fi connection.

7. The method of claim 1, further comprising:
identifying a key value in the message requesting wireless charging;
extracting the key value and a key serial number from the message; and
determining an association of the extracted key value and the extracted key serial number to the second device, wherein authenticating the second device is based at least in part on the association.

8. The method of claim 7, further comprising:
determining a transmit power profile based at least in part on the key value and the key serial number, wherein authenticating the second device is based at least in part on the transmit power profile.

9. The method of claim 8, further comprising:
setting a transmit power of the first device based at least in part on the transmit power profile;
measuring a transmit power of the second device;
comparing the set transmit power of the first device to the measured transmit power of the second device; and
determining that the set transmit power of the first device matches the measured transmit power of the second device,
wherein authenticating the second device is based at least in part on the measured transmit power of the second device matching the set transmit power of the first device.

10. The method of claim 7, further comprising:
determining a resonant frequency profile based at least in part on the key value and the key serial number, wherein authenticating the second device is based at least in part on the resonant frequency profile.

11. The method of claim 7, further comprising:
setting an operating frequency of the first device based at least in part on the resonant frequency profile;
detecting an operating frequency of the second device;
comparing the set operating frequency of the first device to the detected operating frequency of the second device; and
determining that the set operating frequency of the first device matches the detected operating frequency of the second device,
wherein authenticating the second device is based at least in part on the detected operating frequency of the second device matching the set operating frequency of the first device.

12. The method of claim 1, further comprising:
determining a load pattern profile based at least in part on the key value and the key serial number, wherein authenticating the second device is based at least in part on the load pattern profile.

13. The method of claim 12, further comprising:
setting a load pattern of the first device based at least in part on the load pattern profile;
detecting a load pattern of the second device;
comparing the set load pattern of the first device to the detected load pattern of the second device; and
determining that the load pattern of the first device matches the detected load pattern of the second device,
wherein authenticating the second device is based at least in part on the detected load pattern of the second device matching the load pattern of the first device.

14. The method of claim 1, further comprising:
receiving an input comprising at least one of a tactile input, a voice command, or a gesture, or a combination thereof, wherein selecting the wireless charging mode for the first device is based at least in part on the input.

15. The method of claim 1, further comprising:
receiving, from a third device, a request for wireless charging the second device, the request comprising an indication of the wireless charging mode; and
determining that the second device is within a charging footprint of the first device,
wherein providing the wireless charging to the second device is based at least in part on the request from the third device and that the second device is within the charging footprint of the first device.

16. The method of claim 1, further comprising:
wirelessly charging a battery of the second device according to the wireless charging mode.

17. An apparatus for wireless charging, comprising:
a processor,
memory in electronic communication with the processor; and
instructions stored in the memory and executable by the processor to cause the apparatus to:
receive, at the apparatus, a message requesting wireless charging from a second apparatus;
perform, between the apparatus and the second apparatus, a wireless charging setup procedure comprising authenticating the second apparatus and determining a wireless charging mode of the apparatus based at least in part on the message, the wireless charging mode comprising at least one of a wireless power receiver mode or a wireless power transmitter mode;
select the wireless charging mode based at least in part on the wireless charging setup procedure; and
provide, via the apparatus, the wireless charging to the second apparatus according to the wireless charging mode.

18. The apparatus of claim 17, wherein the apparatus comprises a single coil configured to operate both in the wireless power receiver mode and the wireless power transmitter mode simultaneously.

19. The apparatus of claim 17, wherein the instructions are further executable by the processor to cause the apparatus to:
configure a first coil of the apparatus to operate in the wireless power transmitter mode to wirelessly charge the second apparatus based at least in part on selecting the wireless charging mode,
wherein providing the wireless charging to the second apparatus is based at least in part on configuring the first coil of the apparatus to operate in the wireless power transmitter mode

20. An apparatus for wireless charging, comprising:
means for receiving, at the apparatus, a message requesting wireless charging from a second apparatus;
means for performing, between the apparatus and the second apparatus, a wireless charging setup procedure comprising authenticating the second apparatus and determining a wireless charging mode of the apparatus based at least in part on the message, the wireless charging mode comprising at least one of a wireless power receiver mode or a wireless power transmitter mode;
means for selecting the wireless charging mode based at least in part on the wireless charging setup procedure; and
means for providing, via the apparatus, the wireless charging to the second apparatus according to the wireless charging mode.
